(19) United States
(12) Patent Application Publication
(10) Pub. No.: US 2008/0256514 A1
(43) Pub. Date: Oct. 16, 2008

(54) Side-by-side application manifests for single-purpose applications

(75) Inventor: David M. Shiflet, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/784,895

(22) Filed: Apr. 10, 2007

(51) Int. Cl. G06F 9/44

(52) U.S. Cl. 717/120

(57) ABSTRACT

Architecture that adds logic to a client hosting application to process a single-purpose application (SPA) prepared and received as an isolated application. The SPA (e.g., a gadget), as an isolated application, provides one or more manifest files that allow an SPA author to deploy private binary code (e.g., a private ActiveX control) as another file in the SPA distribution, and not exposing the binary code for use by another client application or other programs on the user computer. Thus, only the SPA that came with the binary code will have access to that code.

### BACKGROUND

Single-purpose applications (SPAs), also commonly known as gadgets, widgets, or the like, can be authored using DHTML (dynamic hypertext markup language), JavaScript™, and CSS (cascading style sheets), for example. The gadgets can be rendered by a browser HTML rendering engine (e.g., MSHTML) or similar HTML-centric host. Oftentimes, a gadget will require access to binary code not available through the standard scripting host. Such binary code can be loaded as an ActiveX™ control on a Windows™ platform, for example, or for other gadget platforms, the binary code is written specifically as a gadget plug-in.

An ActiveX control can be identified by a globally unique identifier (GUID) (known as the class ID (CLSID) for a component object model (COM) object) or a name string called a “progid”. Currently, a gadget uses ActiveX controls where the CLSID or progid is listed in the operating system Registry. This places a burden on gadget authors to add extra installation steps to a gadget to deploy the control, and makes all controls available to any ActiveX container on the user computer, not just to the intended gadget.

An SPA (or gadget) package can consist of at least two files: the first file is a manifest file (e.g., XML) that defines properties or metadata about the SPA, for example, the SPA name, icon and description. From the first file, the hosting application finds a name of the second file, which can be an HTML file that defines the core code for the SPA and which is used by a rendering engine to render the SPA. When the rendering engine is rendering the HTML and any associated scripts, the COM engine uses the activation context of the currently executing thread to determine the search path for resolving references to CLSIDs of needed ActiveX objects. The default activation context relies solely on the operating system registry to resolve CLSID or progid references. Thus, the SPA relies on ActiveX components used for other programs.

### SUMMARY

The following presents a simplified summary in order to provide a basic understanding of novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture adds logic to a client hosting application to process a single-purpose application (SPA) prepared and received as an isolated application. The SPA (e.g., a gadget), as an isolated application, provides one or more manifest files that allow an SPA author to deploy private binary code such as an ActiveX component (e.g., an ActiveX control) as just another file in the SPA distribution, and not exposing the binary code for use by another client application or other programs on the user computer. Thus, only the SPA that came with the binary code will have access to that code.

This enables a DHTML-based SPA, for example, to load private copies of the binary code (e.g., ActiveX controls). Moreover, benefits include the ability to reuse shared side-by-side assemblies and to deploy different versions of the same control for use by different SPAs.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system for single-purpose application (SPA) processing.

FIG. 2 illustrates an alternative system for SPA processing and implementation.

FIG. 3 illustrates a diagram of context activation in support of SPA processing.

FIG. 4 illustrates a system of sharing private binary code between multiple SPAs.

FIG. 5 illustrates a method of processing data in accordance SPA implementation of the disclosed architecture.

FIG. 6 illustrates a method of processing SPA files.

FIG. 7 illustrates a block diagram of a computing system for SPA communications and processing in accordance with the disclosed architecture.

FIG. 8 illustrates a schematic block diagram of an exemplary computing environment for SPA communications and processing in accordance with the disclosed architecture.

### DETAILED DESCRIPTION

The disclosed architecture treats a single-purpose application (SPA) (e.g., a gadget) as an isolated application (also commonly referred to as a side-by-side assembly), thereby allowing an SPA author to deploy a private code such as a private ActiveX component (e.g., an ActiveX control) as just another file in the SPA distribution, and not exposing the private ActiveX component for use by other clients on the computer. Thus, only the SPA distributed with the private binary code has access to that binary code (e.g., ActiveX control).

An isolated application is a self-describing application installed with a manifest. In one implementation, a manifest is an XML (extensible markup language) file shipped along with and that describes the isolated application. The isolated application is not registered in the computer operating system (OS), but is available to applications that specify dependencies in the manifest file.

Consider a conventional example where a business networking team wants to deploy a network status SPA. There is no scriptable means to obtain important network data, so the team writes an ActiveX control which the SPA (e.g., gadget) can use to read the data. Since a DLL (dynamic link library) file which hosts the control must be registered in order to be found by the SPA, the team has to deploy the DLL file as a separate file from the compressed distribution file (or CAB-cabinet file) which holds the SPA files. Additionally, the team has to wrap both files into an installer package (e.g., an MSI file). Instead of the simple user experience of downloading and launching the SPA file, the user must install the installer package first, which can raise an additional user account control (UAC) prompt to elevate the process to an administrator level for registering the control.

The disclosed isolated application architecture no longer requires an OS-based installer file (e.g., MSI) and no UAC prompt will be presented when the user installs the SPA. In other words, the user can simply download the SPA as a set of compressed SPA files (e.g., gadget) and launch the file (e.g., by double-clicking).

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

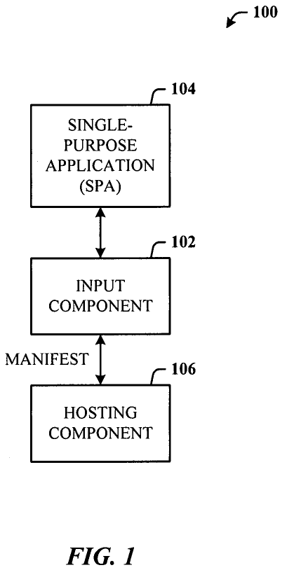

Referring initially to the drawings, FIG. 1 illustrates a computer-implemented system 100 for single-purpose application (SPA) processing. The system 100 can include an input component 102 for receiving an SPA 104 prepared as a side-by-side assembly (or isolated application), and a hosting component 106 for installing the SPA 104 based on a manifest.

A side-by-side assembly can be described by one or more manifests. The assembly can include a group of DLLs, OS classes, COM (component object model) servers, type libraries, or interfaces that are provided to a host application. The files are described in the assembly manifest. The manifest includes metadata for describing the assembly and assembly dependencies. The side-by-side assembly is used by the OS as a fundamental unit of naming, binding, versioning, deployment, and configuration, for example.

The disclosed architecture adds logic to the hosting component 106 (e.g., a host application for the SPA) to process the SPA manifest file shipped in the SPA (e.g., gadget) file package.

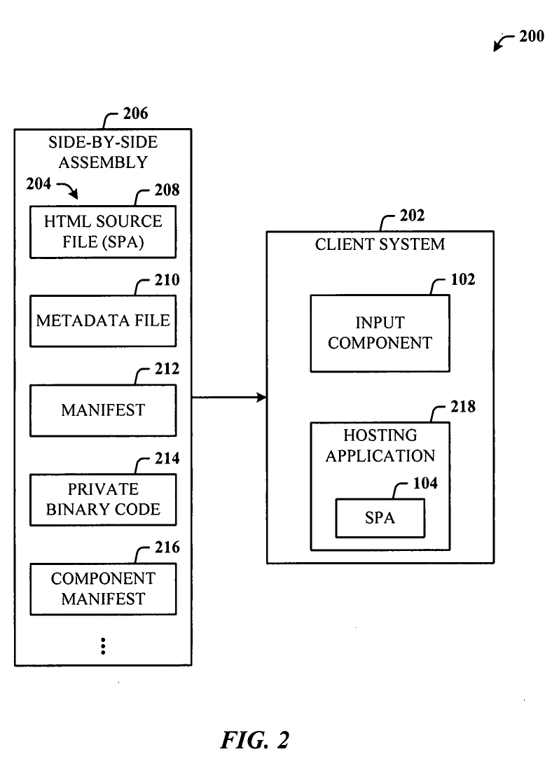

FIG. 2 illustrates an alternative system 200 for SPA processing and implementation. The system 200 includes a client system 202 (e.g., a PC, portable computer, mobile device) for downloading, installing and using the SPA 104. The SPA 104 can be bundled or associated with a set or collection of files 204 prepared as a side-by-side assembly (or isolated application) 206. The files 204 of the assembly 206 can include a source file (e.g., HTML) 208 that is the basis for the SPA 104, a metadata file 210 (e.g., an XML file format) that specifies metadata about the SPA, an SPA manifest file 212, a private binary code file 214 (e.g., a private ActiveX control), and a component manifest file 216. Other files can be included, although this is not a requirement.

In operation, the input component 102 of the client system 202 receives the assembly 206. A hosting application 218 (e.g., as part of the hosting component 106 of FIG. 1) retrieves the name of the application manifest 212 from the metadata 210 (e.g., gadget.xml). This is obtained by including in the SPA manifest schema a tag, the value of which is a name of the application manifest 212. The hosting application 218 creates an in-memory activation context based on the application manifest 212 and which “assembly probing path” is set to the root of the folder where the SPA or assembly files reside.

When loading the HTML source code 208 into the rendering engine, the hosting application 218 activates a new activation context (as differentiated with a default activation context). Object references will first be resolved against one or more component manifests found in the assembly folder, such that if there is the private binary code 214 (e.g., a private ActiveX control) with the associated component manifest 216 in the folder, the private version of the code (or control) 214 would be found and loaded, rather than a centrally-registered copy of the code (or control). Additionally, a previously-installed shared side-by-side assembly can now be loaded by the SPA. When the hosting application 218 itself makes a call to load one or more COM objects, the application 218 restores the default activation context for the duration of the call so that the SPA itself cannot redirect the hosting application 218 to load an untrusted control.

Thus, the assembly files distributed in support of an isolated SPA, if the assembly includes a private ActiveX control, includes the metadata file (e.g., gadget.xml), the SPA HTML source file, the application manifest, the private ActiveX control DLL, and the component manifest for the private ActiveX control. For the purposes of loading COM objects, the SPA will behave like an isolated Win32 application.

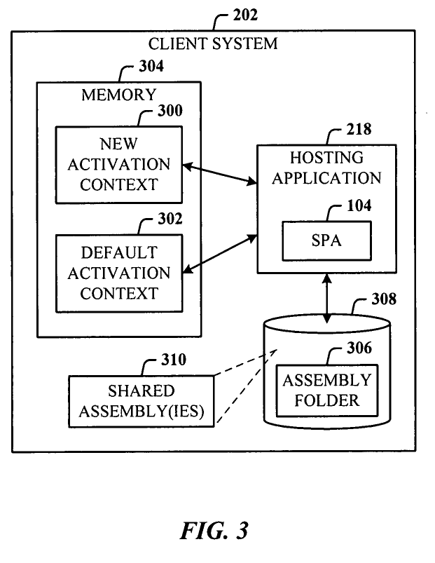

FIG. 3 illustrates a diagram of context activation in support of SPA processing. As indicated above, when loading the HTML source code 208 into the rendering engine, the hosting application 218 of the client 202 activates a new activation context 300 (as differentiated with a default activation context 302) in memory 304. Object references will first be resolved against one or more component manifests found in an assembly folder 306 of a local datastore 308, such that if there is the private binary code (e.g., a private ActiveX control) with the associated component manifest in the folder 306, the private version of the code will be found and loaded, rather than a centrally-registered copy of the code (or control). Additionally, one or more previously-installed shared side-by-side assembly(ies) 310 can now be loaded by the SPA 104. When the hosting application 218 itself makes a call to load one or more COM objects, the application 218 restores the default activation context for the duration of the call so that the SPA 104 itself cannot redirect the hosting application 218 to load an untrusted control.

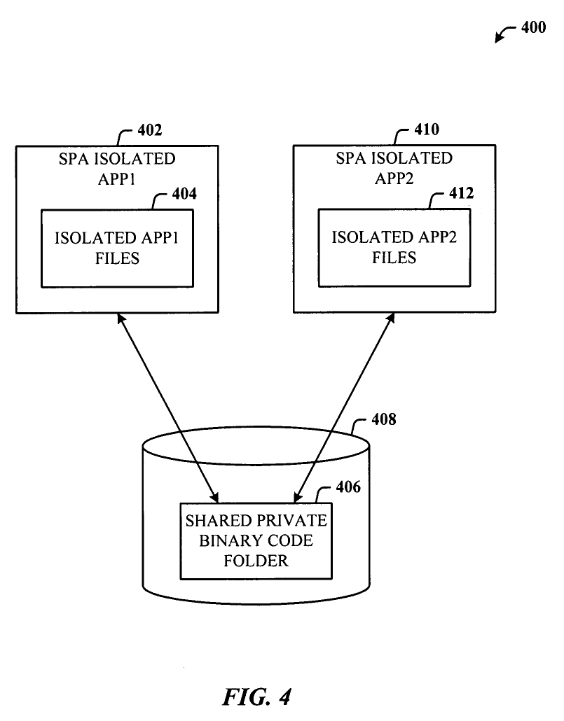

FIG. 4 illustrates a system 400 of sharing private binary code (e.g., a private ActiveX control) between multiple SPAs. Here, a first SPA isolated application 402 (denoted SPA ISOLATED APP1) includes a set of isolated application files 404 (denoted ISOLATED APP1 FILES), less at least the private binary code (e.g., private ActiveX control), which can be stored in a shared folder 406 of a local datastore 408 of the client system. Similarly, a second SPA isolated application 410 (denoted SPA ISOLATED APP2) includes a set of isolated application files 412 (denoted ISOLATED APP2 FILES), less at least the private binary code (e.g., private ActiveX control), which can be stored in the shared folder 406. In other words, SPAs can utilize the same private binary code (e.g., a private ActiveX control) by including manifest information that points to the common or shared folder 406. Alternatively, the shared folder 406 includes distinct private binary code files for multiple different SPAs, each accessible for specific purposes of the corresponding SPA. This facilitates updating the private binary code much simpler on the client system.

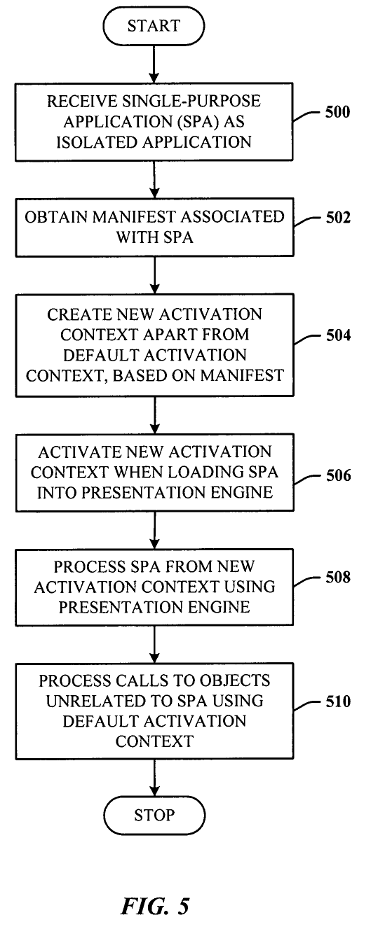

FIG. 5 illustrates a method of processing data in accordance SPA implementation of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

At 500, an SPA is received and prepared as an isolated application. At 502, a manifest associated with the SPA is obtained. At 504, a new activation context is created based on the manifest, the new activation context differentiated from a default activation context. At 506, the new activation context is activated when loading the SPA into a presentation engine. At 508, the SPA is processed from the new activation context using the presentation engine. At 510, calls to objects unrelated to the SPA using the default activation context.

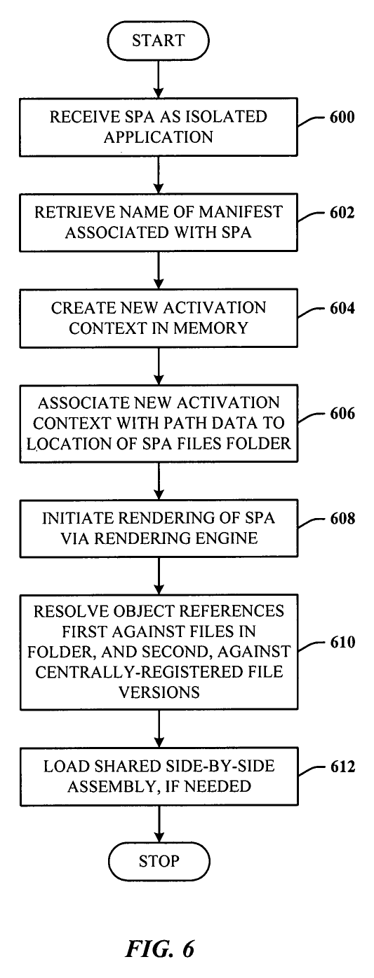

FIG. 6 illustrates a method of processing SPA files. At 600, an SPA is received as an isolated application. At 602, the name of the manifest associated with the spa is received. At 604, a new activation context is created in memory. At 606, the new activation context is associated with path data to the location of the SPA files folder. At 608, rendering of the SPA is initiated via the rendering engine (e.g., MSHTML). At 610, object references are first resolved against the SPA files in the folder, and second, against centrally-registered file versions, if needed. At 612, shared side-by-side assemblies can be loaded, if needed.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

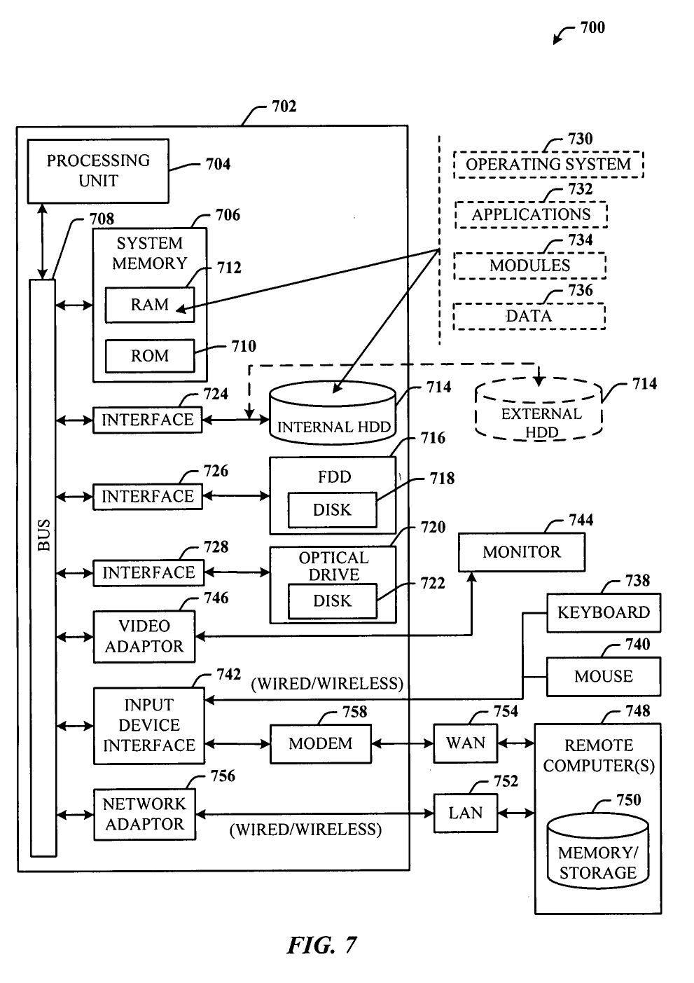

Referring now to FIG. 7, there is illustrated a block diagram of a computing system 700 for SPA communications and processing in accordance with the disclosed architecture. In order to provide additional context for various aspects thereof, FIG. 7 and the following discussion are intended to provide a brief, general description of a suitable computing system 700 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 7, the exemplary computing system 700 for implementing various aspects includes a computer 702, the computer 702 including a processing unit 704, a system memory 706 and a system bus 708. The system bus 708 provides an interface for system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 712, including an operating system 730, one or more application programs 732, other program modules 734 and program data 736. The programs 732, modules 734, and/or data 736 can include the SPA 104, input component 102, hosting component 106, side-by-side assembly 206 and files 204, hosting application 218, for example. All or portions of the operating system, applications, modules, and/or data can also be cached in the RAM 712. It is to be appreciated that the disclosed architecture can be implemented with various commercially available operating systems or combinations of operating systems.

A user can enter commands and information into the computer 702 through one or more wired/wireless input devices, for example, a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 via an interface, such as a video adapter 746. In addition to the monitor 744, a computer typically includes other peripheral output devices (not shown), such as speakers, printers, etc.

The computer 702 may operate in a networked environment using logical connections via wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the local network 752 through a wired and/or wireless communication network interface or adapter 756. The adaptor 756 may facilitate wired or wireless communication to the LAN 752, which may also include a wireless access point disposed thereon for communicating with the wireless adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

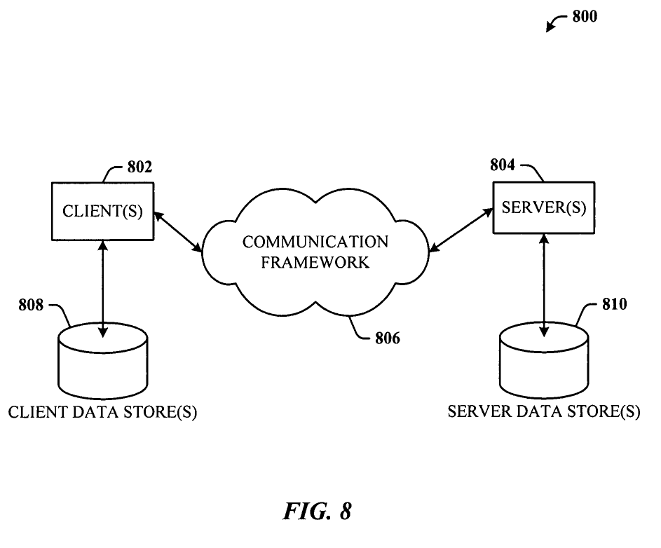

Referring now to FIG. 8, there is illustrated a schematic block diagram of an exemplary computing environment 800 for SPA communications and processing in accordance with the disclosed architecture. The system 800 includes one or more client(s) 802. The client(s) 802 can be hardware and/or software (e.g., threads, processes, computing devices). The client(s) 802 can house cookie(s) and/or associated contextual information, for example.

The system 800 also includes one or more server(s) 804. The server(s) 804 can also be hardware and/or software (e.g., threads, processes, computing devices). The servers 804 can house threads to perform transformations by employing the architecture, for example. One possible communication between a client 802 and a server 804 can be in the form of a data packet adapted to be transmitted between two or more computer processes. The data packet may include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804. The clients 802 can include the client system 202, for example.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system, comprising:
an input component for receiving a single-purpose application (SPA) prepared as a side-by-side assembly; and
a hosting component for installing the SPA based on a manifest.

2. The system of claim 1, wherein the assembly includes the SPA as an HTML source file, metadata about the SPA, the manifest, private binary code, and a component manifest for the private binary code.

3. The system of claim 2, wherein the private binary code is a private ActiveX control DLL (dynamic link library) file, and the metadata is expressed in an XML (extensible markup language) format.

4. The system of claim 3, wherein the hosting component retrieves a name of the manifest from the metadata.

5. The system of claim 2, wherein the metadata includes a value that identifies the manifest.

6. The system of claim 1, wherein the manifest is part of the side-by-side assembly.

7. The system of claim 1, wherein the hosting component creates a new activation context in-memory based on the manifest and associates a path to a folder where files of the assembly are stored.

8. The system of claim 7, wherein the hosting component loads source code of the SPA into a rendering engine and activates the new activation context.

9. The system of claim 7, wherein the hosting component resolves an object reference against a component manifest found in the folder before a centrally-registered copy of the component manifest.

10. The system of claim 1, wherein the hosting component loads a previously-installed shared side-by-side assembly after processing the side-by-side assembly.

11. The system of claim 1, wherein the hosting component restores a default activation context for duration of a call to load a COM object to prevent the SPA from calling an untrusted control.

12. A computer-implemented method of processing data, comprising:
receiving an SPA prepared as an isolated application;
obtaining a manifest associated with the SPA;
creating a new activation context based on the manifest;
activating the new activation context when loading the SPA into a presentation engine; and
processing the SPA from the new activation context using the presentation engine.

13. The method of claim 12, further comprising retrieving a name of the manifest associated with the SPA.

14. The method of claim 12, further comprising creating the new activation context in-memory based on the manifest.

15. The method of claim 14, further comprising setting an assembly probing path of the manifest to a location where SPA-related files reside.

16. The method of claim 12, further comprising resolving an object reference against one or more component manifests based on a file location path obtained from the manifest.

17. The method of claim 16, further comprising loading a private ActiveX control associated with the file location path before loading a centrally-registered ActiveX control.

18. The method of claim 12, further comprising loading a shared side-by-side assembly associated with the SPA.

19. The method of claim 12, further comprising restoring a default activation context for duration of a call by a hosting application of the SPA.

20. A computer-implemented system, comprising:
computer-implemented means for receiving an SPA prepared as an isolated application;
computer-implemented means for obtaining a manifest associated with the SPA;
computer-implemented means for creating a new activation context based on the manifest;
computer-implemented means for activating the new activation context when loading the SPA into a presentation engine; and
computer-implemented means for processing the SPA from the new activation context using the presentation engine.
